(19) United States
(12) Patent Application Publication
(10) Pub. No.: US 2024/0332952 A1
(43) Pub. Date: Oct. 3, 2024

(54) SHORT-CIRCUITING DEVICE

(71) Applicant: Siemens Aktiengesellschaft, München (DE)

(72) Inventors: Peter Schegner, Dresden (DE); Karsten Wenzlaff, Dresden (DE)

(21) Appl. No.: 18/575,364

(22) PCT Filed: Jun. 29, 2021
(86) PCT No.: PCT/EP2021/067785

§ 371 Date: Dec. 29, 2023

(51) Int. Cl. H02H 7/22; H02H 1/00

(52) U.S. Cl. CPC H02H 7/222; H02H 1/0015

(57) ABSTRACT

A short-circuiting device and a method for quenching a fault arc using a short-circuiting device. The device is used to quench a fault arc in switchgear. The short-circuiting device has at least one power electronic switch for switching on and switching off a short-circuit current. After a fault arc is detected in one or more outer conductors of the switchgear, an ignition of the at least one power electronic switch is triggered such that the at least one power electronic switch generates a short-circuit current in the one or more outer conductors affected by the fault arc until the subsequent zero-crossing.

The present invention relates to a short-circuiting device for quenching a fault arc, a switchgear having such a short-circuiting device, and a method for quenching a fault arc using a short-circuiting device.

In switching systems, for example, low-voltage facilities such as low-voltage circuits and low-voltage grids, short circuits usually occur together with serial or parallel fault arcs, also referred to as interference arcs. While serial fault arcs (arcs in series to the load) can arise upon the interruption of a conductor or as a result of loose contacts, reference is made to a parallel fault arc (arc parallel to the load) if it occurs between two conductors or system parts at different potentials: between an outer conductor and the neutral conductor (N), between an outer conductor (L) and the protective conductor (PE) or ground, or between two outer conductors. Parallel fault 18 arcs can be caused by aging of insulation material or conductive foreign material between conductors. In many cases, the parallel fault arcs also arise as a result of a serial fault arc, for example, by improper work or incorrectly dimensioned equipment. The fault current of a serial fault arc is limited by the load and is therefore lower than that of a parallel fault arc. The fault current of a parallel fault arc can have the strength of the short-circuit current.

Especially in high-performance distribution and switchgear systems, fault arcs can result in devastating destruction of equipment, system parts, or complete switchgear systems. To reduce damage and avoid a longer failure of the power supply, it is necessary to detect and quench fault arcs, in particular high amperage or parallel fault arcs, in a few milliseconds. Conventional protective systems for power supply facilities cannot reliably maintain the necessary chronological requirements.

Fault arc detectors are used for detecting fault arcs, which detect a fault arc in the system by evaluating optical signals and possibly further release conditions, for example, an overcurrent in the circuit, see, for example, DE102015207802A1 (Dehn+Söhne GmbH & Co. KG) 3 Nov. 2016.

In general, a short-circuiting device is used for quenching the fault arc, which produces a short circuit before the fault arc after receiving a trigger signal from a fault arc detector in the circuit, see, for example, DE941914101 (Klöckner-Moeller GmbH) 09.05.1996 and WO2000062320A1 (Moeller GmbH) 19 Oct. 2000. Arc voltage can therefore no longer build up at the location of the fault arc and the fault arc is quenched.

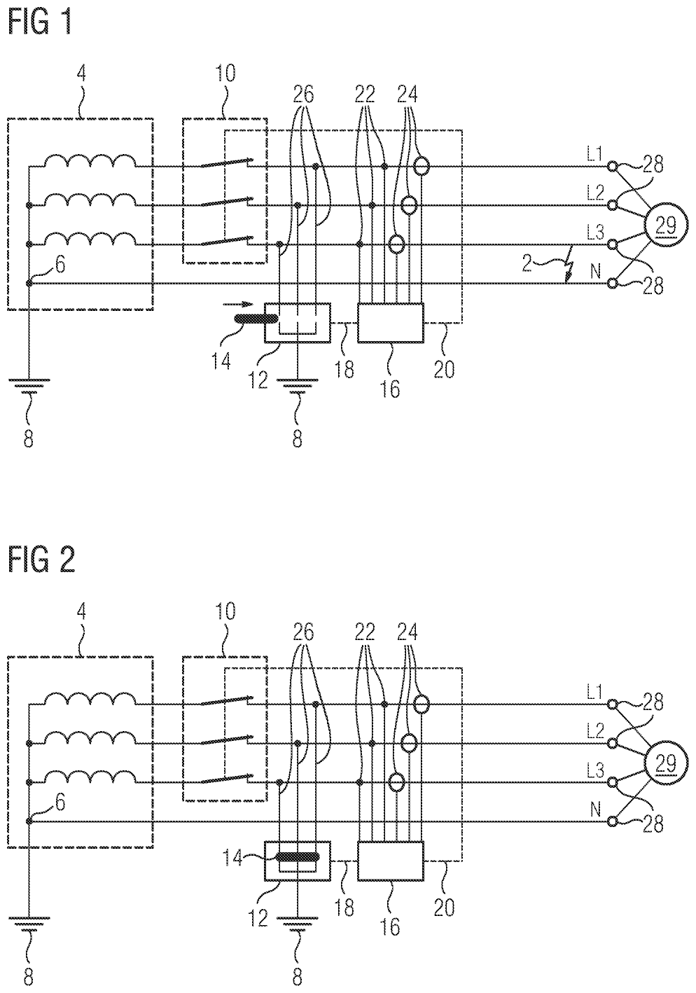

The function of such a short-circuiting device 12 is illustrated in principle on the basis of a low-voltage grid having a three-phase transformer 4 as the current source in FIGS. 1 to 3. The three strands of the three-phase transformer 4 are connected to one another in a star point connected to a ground point 8, which is also the connection point for a neutral conductor N. Low-voltage grids are generally embodied having a grounded neutral conductor N as four-conductor systems, in order to also allow single-phase loads to be connected. Electrical energy is guided from the three-phase transformer 4 via three outer conductors L1, L2, and L3 to a load connection 28, to which an electrical load 29 is connected.

A power switch 10 having protective function, which has switching contacts for interrupting the outer conductors L1, L2, and L3, is connected between the three-phase transformer 4 and the load connection 28.

The low-voltage grid additionally has a short-circuiting device 12, which is connected to the outer conductors L1, L2, and L3 by three feed lines 26, which each contact one of the outer conductors L1, L2, and L3 between the power switch 10 and the load connections 28.

The low-voltage grid additionally has a control unit 16, which is equipped with evaluation and activation electronics and is capable, on the basis of signals, for example, optical signals, current values, and voltage values, which it receives from sensors 22, 24 that can acquire current values and voltage values in the outer conductors L1, L2, and L3 and arc radiation, of detecting a fault arc in the low-voltage grid and as a result giving corresponding trigger signals via control lines 18, 20 to the short-circuiting device 12 and the power switch 10.

FIG. 1 shows a first point in time, at which a fault arc 2 burns between an outer conductor L3 and the neutral conductor N. The control unit 16 recognizes on the basis of the signals received from the sensors 22, 24 that a fault arc 2 exists and transmits a trigger signal to the short-circuiting device 12 via the control line 18. The trigger signal triggers an insertion, driven by a gas or a spring, for example, of an electrically conductive connecting 27 element 14 at the three feed lines 26, by which the outer conductors L1, L2, and L3 are short-circuited. FIG. 2 shows a following second point in time at which the fault arc 2, from which the energy source was withdrawn in this manner, is quenched due to the short-circuit current flowing via the short-circuiting device 12. FIG. 3 shows a following third point in time at which the power switch 10, triggered by a corresponding trigger signal received via the control line 20 from the control unit 16, has opened its switch contacts to interrupt the outer conductors L1, L2, and L3, by which the short-circuit current flowing via the short-circuiting device 12 was switched off.

To restart the low-voltage system, the short-circuiting device usually has to be replaced, due to which a longer failure of the low-voltage system results, with the known negative consequences of a power failure. There is therefore a need for an improved short-circuiting device.

The object is achieved according to the invention by a short-circuiting device having the features specified in claim 1. The object is achieved according to the invention by a switchgear having the features specified in claim 4. The object is additionally achieved by a method having the features specified in claim 8.

The short-circuiting device according to the invention is configured for quenching a fault arc in a switchgear. The term switchgear comprises low-voltage systems, such as low-voltage switchgears and low-voltage distribution systems, and moderate-voltage systems, such as moderate-voltage switchgears and moderate-voltage distribution systems. AC voltages up to 1000 V and DC voltages up to 1500 V are designated as low voltage. Moderate voltage, which adjoins the voltage ranges of low voltage, but the range of which is not standardized, is understood as an AC voltage in the range greater than 1000 V up to 52 kV inclusive and a DC voltage greater than 1500 V to the beginning of the high-voltage range. The short-circuiting device has at least one power-electronic switch for switching a short-circuit current on and off. The power-electronic switch can be designed as a thyristor switch or as a Triac.

The switchgear according to the invention has a short-circuiting device as described above. The switchgear additionally has at least one outer conductor. The outer conductor or conductors of the switchgear are used to transport electrical energy from an electrical energy source of the switchgear to an electric load of the switchgear; for this purpose, the outer conductors establish an electrically conductive connection between the energy source and the electric load. The switchgear additionally has a control unit, which is configured to detect a fault arc that affects one or more of the outer conductors and to activate the short-circuiting device if a fault arc is detected. A fault arc affects an outer conductor if it begins or ends at the outer conductor.

The method according to the invention is used to quench a fault arc using a short-circuiting device as described above. The method is distinguished in that after a fault arc is detected in one or more outer conductors of a switchgear, an ignition of the at least one power-electronic switch is triggered, so that the at least one power-electronic switch generates a short-circuit current in the one or more outer conductors affected by the fault arc to the following zero crossing. It is presumed here that the voltage applied in the one or more outer conductors is an AC voltage which has a zero crossing.

The invention is based on the finding that a power-electronic switch in the form of a fast semiconductor switch is very suitable as a short-circuiting device. A power-electronic switch can thus transmit a short-circuit current after it is actuated until it interrupts the short-circuit current again. During the time interval in which the short-circuit current flows, the fault arc is quenched.

Using the invention, parallel fault arcs in switchgears can be quenched rapidly by a power-electronic switch. The power-electronic switch can switch off the short-circuit current after the arc is quenched, so that the switchgear, without all poles of the switchgear having to be switched off after the quenching of the fault arc, for example, by an upstream power switch, can be resupplied again or the outer conductors not affected by the fault can continue to supply the switchgear over the entire time without a relevant voltage drop.

Due to the direct and rapid arc quenching, the system can be operated again directly after the fault is remedied if the cause of the arc or a new arc ignition is no longer existent.

Advantageous embodiments and refinements of the invention are specified in the dependent claims. The method according to the invention can also be refined here according to the dependent device claims, and vice versa.

According to one preferred embodiment of the short-circuiting device, the short-circuiting device has one separately activatable power-electronic switch per outer conductor of the switchgear. It is advantageous here that parallel fault arcs in switchgears can be quenched rapidly by a power-electronic switch in a fault-loop selective manner. “Fault-loop selective” means that the power-electronic switch only selectively switches a short-circuit in that current loop or in those current loops which is/are affected by a fault arc forming the “fault”. In the event of a short-circuit between two outer conductors, the two power-electronic switches assigned to the outer conductors have to be switched on. Fault-loop selective arc quenching is thus possible using the invention, which does not result in all poles of the system being switched off, but rather only causes a voltage drop in the fault-affected conductor or the fault-affected conductors. Three individually activatable power-electronic switches, which may each be activated per detected fault loop, can be used for the short-circuiting device in a three-phase system. The activation is performed by a control unit. Only a single activation of a power-electronic switch assigned to the fault loop takes place per arc detection, so that the power-electronic switch ignites through and does not reignite again in the next current zero crossing. The power-electronic switch thus does not have to be dimensioned for continuous current, but rather only for the peak short-circuit current.

According to one preferred embodiment, the at least one power-electronic switch is a thyristor or a Triac. A thyristor is very suitable in particular here: A thyristor is conductive after its ignition until the maintenance current is not reached, thus at the latest until the voltage zero crossing if an AC voltage is applied. A thyristor can thus conduct a short-circuit current after its ignition until it automatically interrupts the short-circuit current again at the voltage zero crossing. During the time interval in which short-circuit current flows, the fault arc is quenched. A Triac is in principle an antiparallel circuit of two thyristors; this enables it to switch alternating current.

According to one preferred embodiment of the switchgear, the short-circuiting device has one separately activatable power-electronic switch per outer conductor of the switchgear, and the control unit is configured to activate only the power-electronic switch or switches of the short-circuiting device to switch on a short-circuit current which is/are assigned to one or more outer conductors affected by the fault arc. It is advantageous here that parallel fault arcs in switchgears can be quenched rapidly in fault-loop selective manner by a power-electronic switch. “Fault-loop selective” means that the power-electronic switch only selectively switches a short circuit in that current loop or in those current loops which is/are affected by a fault arc forming the “fault.” Fault-loop selective arc quenching is thus possible using the invention, which does not result in all poles of the system being switched off, but rather only causes a voltage drop in the fault-affected conductor or the fault-affected conductors.

According to one preferred embodiment of the switchgear, the switchgear has a protective device for interrupting a current in the one or more outer conductors affected by the fault arc. The protective device can be a power switch 11 here, such as an ACB or an MCCB. Since the power-electronic switches can switch off the short-circuit current themselves, in general a protective device is not necessary for this purpose; an upstream protective device only has to be present as a fallback protection, so that the fault arc can be quenched in the case that the fault arc cannot be quenched using the power-electronic switches.

According to one preferred embodiment of the method, if a fault arc occurs again after the zero crossing, the at least one power-electronic switch is ignited again and a protective device for interrupting a current in the one or more outer conductors affected by the fault arc is activated so that it interrupts the short-circuit current flowing through the at least one power-electronic switch. It is advantageous here that the protective device forms a fallback protection, in order to protect the power-electronic switch from thermal overload due to a lasting short-circuit current in the event of repeated activation, if the power-electronic switch was activated again due to a renewed fault arc ignition.

According to one preferred embodiment of the method, only that power-electronic switch of the short-circuiting device, which has one separately activatable power-electronic switch per outer conductor of the switchgear, is ignited which is assigned to the one or more outer conductors affected by the fault arc. It is advantageous here that fault-loop selective arc quenching is possible using the invention, which does not result in all poles of the system being switched off, but only causes a voltage drop in the fault-affected conductor.

According to one preferred embodiment of the method, the switchgear is operated again after the quenching of the fault arc if the cause of the fault arc is no longer existent and no renewed fault arc ignition takes place. It is advantageous here that the switchgear is ready for use again relatively quickly after a fault arc.

A further preferred embodiment of the invention is a computer program having software code sections for carrying out the method as described above.

A further preferred embodiment of the invention is a computer program product which can be loaded directly into the internal memory of a digital computing unit and comprises software code sections, using which the method as described above is carried out.

The computer program product is designed to be executable in a control unit. The computer program product can be designed to be storable in a memory as software or firmware and executable by a processor. Alternatively or additionally, the computer program product can also be designed at least partially as a hardwired circuit, for example as an ASIC. The computer program product is designed to receive and evaluate measured values acquired by sensors and to generate activation commands to power-electronic switches of the short-circuiting device and a protective device. According to the invention, the computer program product is designed to implement and carry out at least one embodiment of the outlined method for quenching a fault arc using a short-circuiting device. The computer program product can unify all subfunctions of the method in itself, thus can be designed as monolithic. Alternatively, the computer program product can also be designed as segmented and distribute respective subfunctions onto segments, which are executed on separate hardware. For example, one part of the method can be carried out in a control unit and another part of the method can be carried out in a higher-order control unit, such as an SPS or a computer cloud.

Furthermore, a computer program product is proposed which can be loaded directly into the internal memory of a digital computing unit and comprises software code sections, using which the steps of the method described herein are carried out when the product runs on the computing unit. The computer program product can be stored on a data carrier, such as a USB memory stick, a DVD or a CD-ROM, a flash memory, an EEPROM, or an SD card. The computer program product can also be provided in the form of a signal loadable via a wired or wireless network.

The method is implemented to be carried out automatically, preferably in the form of a computer program. The invention is therefore, on the one hand, also a computer program having program code instructions executable by a computer and, on the other hand, a memory medium having such a computer program, thus a computer program product having program code means, and finally also an energy source or a tertiary regulation unit, in the memory of which such a computer program is loaded or loadable as means for carrying out the method and its embodiments.

Instead of a computer program having individual program code instructions, the implementation of the method described here and hereinafter can also take place in the form of firmware. It is clear to a person skilled in the art that instead of an implementation of a method in software, an implementation in firmware or in firmware and software or in firmware and hardware is always also possible. Therefore, for the description presented here, the term software or the term computer program is also to comprise other possible implementations, namely in particular an implementation in firmware or in firmware and software or in firmware and hardware.

The above-described properties, features, and advantages of this invention and the manner in which they are achieved will become clearer and more comprehensible by way of the following description, which is explained in more detail on the basis of the drawing. In the schematic figures, which are not to scale,

FIGS. 1 to 3 show a conventional short-circuiting device at three successive points in time; and

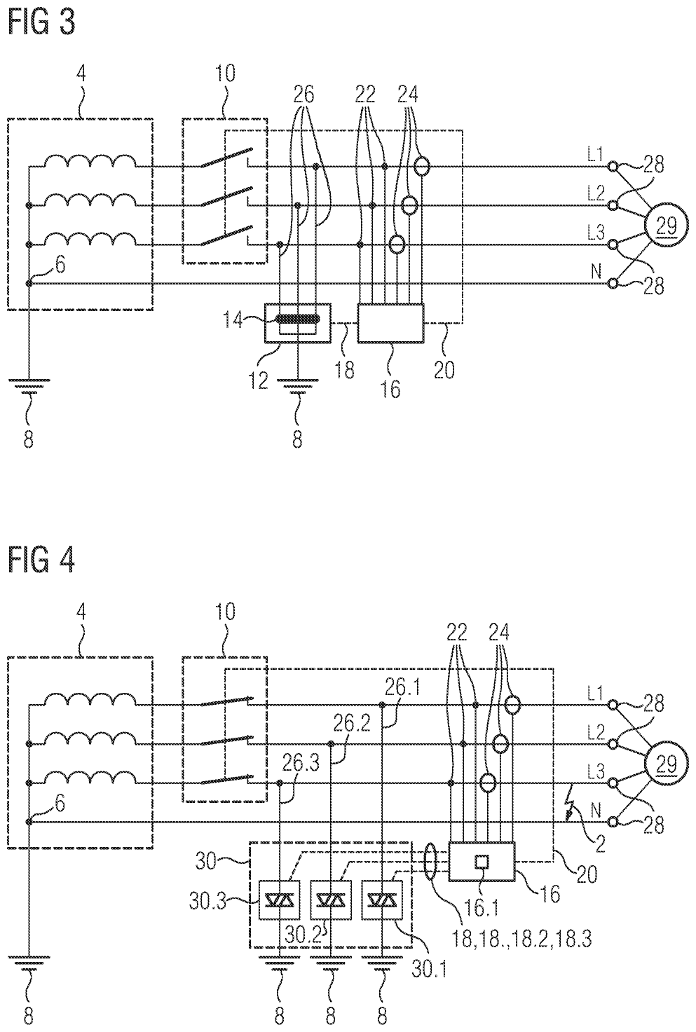

FIG. 4 shows a short-circuiting device according to the invention.

FIG. 4 shows the function in principle of a short-circuiting device 12 according to the invention on the basis of a low-voltage network having a three-phase transformer 4 as a current source. The three strands of the three-phase transformer 4 are connected to one another in a star point 6 connected to a ground point 8, which is also the connection point for a neutral conductor N. From the three-phase transformer 4, electrical energy is guided via three outer conductors L1, L2, and L3 to a load connection 28, for example, a three-phase socket, to which an electrical load 29 is connected, for example, a three-phase electric motor or an electric oven. It is also possible that a single-phase load, such as a single-phase electric motor, is connected to one of the three outer conductors L1, L2, and L3 and to the neutral conductor N.

A power switch 10, for example, an ACB or an MCCB, which has switching contacts for interrupting the outer conductors L1, L2, and L3, is connected between the three-phase transformer 4 and the load connection 28 as a protective device.

The low-voltage network additionally has a short-circuiting device 30, which is connected by three feed lines 26.1, 26.2, and 26.3, which each contact one of the outer conductors L1, L2, and L3 between the power switch 10 and the load connections 28, to the three outer conductors L1, L2, and L3. The short-circuiting device 30 has three thyristor switches, i.e., a first thyristor switch 30.1, a second thyristor switch 30.2, and a third thyristor switch 30.3, which are capable of connecting each of the outer conductors L1, L2, L3 separately through the corresponding feed line 26.1, 26.2, 26.3 to a grounding point 8. The three thyristor switches 30.1, 30.2, and 30.3 are designed as Triacs here, so that they can switch AC voltage.

The low-voltage network additionally has a control unit 16, which is equipped with evaluation and activation electronics and is capable on the basis of signals, such as optical signals, current values, and voltage values, which it receives from sensors 22, 24, which can acquire current values and voltage values in the outer conductors L1, L2, and L3 and arc radiation, of detecting a fault arc in the low-voltage network and as a result giving corresponding trigger signals via control lines 18, 20 to the short-circuiting device 12 and the power switch 10. The control unit 16 has a computing unit 16.1, which is adapted to execute a computer program that carries out the steps of a method according to the invention.

The control lines 18 have three control lines, i.e., a first control line 18.1, a second control line 18.2, and a third control line 18.3, via which the control unit 16 can activate the three thyristor switches 30.1 separately.

After a fault arc 2 is detected in one or more outer conductors L1, L2, L3 of the low-voltage system on the basis of signals which it receives from the sensors 22, 24, the control unit 16, controlled by the computing unit 16.1, which executes a computer program for carrying out the steps of the method according to the invention, triggers an ignition of the at least one thyristor switch 30.1, 30.2, 30.3, so that the at least one thyristor switch 30.1, 30.2, 30.3 generates a short-circuit current until the following zero crossing in the one or more outer conductors L1, L2, L3 affected by the fault arc. The short-circuit current flows here through the affected outer conductor or conductors L1, L2, L3, the corresponding feed line or lines 26.1, 26.2, 26.3, and through the corresponding thyristor switch or switches 30.1, 30.2, 30.3. For example, a fault arc 2 between the third outer conductor L3 and the neutral conductor N, as shown in FIG. 4, would result in an ignition of the third thyristor switch 30.3 assigned to the third outer conductor L3. A short-circuit current would thus result from the third outer conductor L3 via the feed line 26.3 corresponding to the third outer conductor L3 and the third thyristor switch 30.3 to a grounding point 8.

In another example, a fault arc 2 (not shown in FIG. 4) between the first outer conductor L1 and the second outer conductor L2 would result in an ignition of the thyristor switches 30.1 and 30.2 assigned to these two outer conductors L1 and L2.

If a fault arc 2 occurs again after the zero crossing of the voltage in the outer conductor L1, L2, L3 affected by the fault arc 2, the control unit 16 causes the at least one thyristor switch 30.1, 30.2, 30.3 assigned to the affected outer conductor L1, L2, L3 to be ignited again and the power switch 10 to be activated to interrupt a current in the one or more outer conductors L1, L2, L3 affected by the fault arc 2 so that the power switch 10 interrupts the short-circuit current flowing through the at least one thyristor switch 30.1, 30.2, 30.3.

The low-voltage system is operated again after the quenching of the fault arc 2 as soon as the cause of the fault arc 2 is no longer existent and no renewed fault arc ignition takes place.

1-13. (canceled)

14. A short-circuiting device for quenching a fault arc in a switchgear system, the device comprising:
at least one power-electronic switch for selectively switching a short-circuit current on and off.

15. The short-circuiting device according to claim 14, which comprises one separately activatable power-electronic switch for each outer conductor of the switchgear system.

16. The short-circuiting device as according to claim 14, wherein said at least one power-electronic switch is a thyristor or a Triac.

17. A switchgear, comprising:
at least one outer conductor;
a short-circuiting device according to claim 14; and
a control unit for detecting a fault arc affecting one or more of said at least one outer conductor and for activating said short-circuiting device when a fault arc is detected.

18. The switchgear according to claim 17, wherein the switchgear is a low-voltage system or a medium-voltage system.

19. The switchgear according to claim 17, wherein:
said short-circuiting device has one separately activatable power-electronic switch for each of said at least one outer conductor; and
said control unit is configured to activate, for switching on a short-circuit current, only a respective said power-electronic switch or switches of said short-circuiting device which is or are assigned to said one or more outer conductors affected by the fault arc.

20. The switchgear according to claim 17, comprising a protective device for interrupting a current in said one or more outer conductors affected by the fault arc.

21. A method for quenching a fault arc in one or more outer conductors of a switchgear, the method comprising:
providing a short-circuiting device according to claim 14;
when a fault arc is detected in the one or more outer conductors, triggering an ignition of the at least one power-electronic switch, to generate with the at least one power-electronic switch a short-circuit current until a following zero crossing in the one or more outer conductors affected by the fault arc.

22. The method according to claim 21, wherein the short-circuiting device has one separately activatable power-electronic switch per outer conductor of the switchgear, and the method comprises igniting only those power-electronic switches which are assigned to the one or more outer conductors affected by the fault arc.

23. The method according to claim 21, wherein, when a further fault arc occurs after the voltage zero crossing in the one or more outer conductors affected by the fault arc, igniting the at least one power-electronic switch again and activating a protective device for interrupting a current in the one or more outer conductors affected by the fault arc in order to interrupt the short-circuit current flowing through the at least one power-electronic switch.

24. The method according to claim 21, which comprises once more operating the switchgear after the quenching of the fault arc if a cause of the fault arc is no longer existent and no further ignition of a fault arc occurs.

25. A non-transitory computer program comprising software code sections for carrying out the method according to claim 21.

26. A non-transitory computer program product, which can be loaded directly into an internal memory of a digital computing unit and which contains software code sections configured to carry out the method according to claim 21 when the computer program product runs on the computing unit.
